(19) United States
(12) Patent Application Publication
(10) Pub. No.: US 2016/0086159 A1
(43) Pub. Date: Mar. 24, 2016

(54) APPLICATION IDENTIFIER (AID) PRIORITIZATION OF SECURITY MODULE APPLICATIONS

(71) Applicant: STMicroelectronics, Inc., Coppell, TX (US)

(72) Inventor: Prasad Golla, Bridgewater, NJ (US)

(21) Appl. No.: 14/853,703

(22) Filed: Sep. 14, 2015

Related U.S. Application Data
(60) Provisional application No. 62/054,872, filed on Sep. 24, 2014.

(51) Int. Cl. G06Q 20/32; G06Q 20/40

(52) U.S. Cl. CPC G06Q 20/3229; G06Q 20/3278; G06Q 20/401; G06Q 2220/00

(57) ABSTRACT

Secure transactions in a mobile device can be prioritized to execute on a security module in the mobile device over execution on a remote device. An STK function in a security module of a mobile device is initialized. A communication path between the security module and a secure wireless interface (e.g., NFC) circuit of the mobile device is initialized. The STK function provides priority table information. The priority table information includes application identifiers and links to processor executable software functions associated with the application identifiers. At least one of the processor executable software functions is stored in the security module, and at least one of the processor executable software functions stored in the security module is prioritized over a corresponding processor executable software function executable outside of the security module. The priority table is loaded in the secure wireless interface circuit with the priority table information passed over the communication path.

### BACKGROUND

1. Technical Field

The present disclosure generally relates to secure mobile network services. More particularly, but not exclusively, the present disclosure relates to prioritizing applications in a mobile device security module.

2. Description of the Related Art

A mobile network device includes a subscriber identity module, often called a SIM or a SIM card. The SIM card has a protected memory, which stores private data. A SIM card represents one type of security module used in mobile devices, though other types of security modules such as secure elements, secure memories, and the like, are also considered.

The private data stored in the security module can include credit card information, bank account information, identity, other customer-specific data (e.g., biometric data, finger prints, digital transaction certificates, and the like). The private data can also include other data such as mobile network account information, passwords, phonebooks, and the like.

FIG. 1A illustrates a particular payment landscape. In a first view, a user 2 is holding a mobile device 4 in proximity to a payment device 6. The payment device 6 is authorized by several financial institutions to perform financial transactions, such as payments for goods and services. When the mobile device 4 is brought in proximity to the payment device 6, near field communication (NFC) circuitry in both devices is activated. A secure communicative relationship between the two devices is formed, and secure data is passed between the devices.

In a second view in FIG. 1B, a block diagram illustrates one aspect of the secure transaction 8A shown in the first view between the mobile device and the payment device. In FIG. 1B, the secure transaction 8A is illustrated as bi-directional, but in other cases, a transaction may broadcast or otherwise pass information in only one direction. When the two devices are brought in proximity to each other, NFC reader circuitry 10 in the payment device 6 activates NFC controller circuitry 12 in the mobile device 4. The two NFC circuits cooperate to pass secure data of a secure transaction 8A. As illustrated in the block diagram, at least some portions of the information of the secure transaction 8A are passed between the SIM card 14 of the mobile device 4 and the NFC controller circuitry 12 of the mobile device 4 via a single wire protocol (SWP) bus 16; the information is further passed between the NFC controller circuitry 12 of the mobile device 4 and the NFC reader circuitry 10 of the payment device 6.

In addition to the NFC controller circuitry 12, the mobile device 4 also includes a host central processing unit (CPU) 16. The host CPU 16 manages the mobile device 4. The host CPU 16 is configured to manage some aspects of the NFC controller 12, and the host CPU 16 is also configured to manage some aspects of the communications of the mobile device that occur over the cellular network.

FIG. 2 illustrates a more recent payment landscape that is becoming available. Similarities and differences between the payment landscapes of FIGS. 1A, 1B, and 2 are apparent.

The mobile device 4 of FIG. 2 includes a host CPU 18, NFC controller circuitry 12, and a SIM card 14. The SWP bus between the NFC controller circuitry may or may not exist in the mobile device of FIG. 2, but if the SWP bus does exist, the bus is less often used in secure transactions. Instead, when the mobile device is in proximity to a payment device, the NFC circuitry passes secure data of a bidirectional secure transaction 8B between the payment device 6 and the host CPU 18. Then, once it has access to the secure data, the host CPU 18 determines whether the secure information should be associated with the SIM card or with a remotely located computing device 20. FIG. 2 graphically shows the remote computing device 20 as a cloud. The illustration is provided for simplicity and understanding that such remote devices may be accessed over a wide area network such as a cellular system and the Internet. Various computing devices are also illustrated and configured to provide cloud computing, banking services, platform as a service (PaaS), and other functions. These functions are accessible to the mobile device 4 via a wireless cellular network through the host CPU 18.

In some cases of the more recent payment landscape of FIG. 2, the mobile device maker has formed a host card emulation (HCE) layer using the host CPU 18, which is responsible for routing transactions originating in the NFC controller circuitry 12 through the wireless network. The HCE layer is presented to the NFC controller circuitry 12 as a smart card. That is, when the NFC controller circuitry 12 communicates with the host CPU 18, the NFC controller circuitry 12 uses the same hardware and software interface it would use to communicate with a physically present smart card such as the SIM card 14. On the other hand, in the host CPU 18, smart card signaling is emulated, but smart card functionality is remotely provided by the remotely located computing device 20 via Internet-based services accessed over the wireless network.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which in and of itself may also be inventive.

### BRIEF SUMMARY

In accordance with some mobile device embodiments described herein, transactions that are activated via a secure wireless interface (e.g., near field communications (NFC)) circuit can be handled within a security module (e.g., a SIM card) or handled via a remote computing device. In the second circumstance, a host controller on the mobile device communicates the information between the secure wireless interface circuit and the remote computing device via a wireless network such as a cellular network that conforms to a 3G, 4G GSM protocol, a 5G protocol, or some other wireless communication network.

In the embodiments described herein, methods and devices describe how to prioritize the handling of the secure transactions. In some embodiments a conventional routing table is loaded at boot-up in the secure wireless controller or in a memory associated with a host-controller. Then, also at boot-up or at another time, a prioritized application identifier (AID) routing table in a secure wireless circuit is loaded or otherwise populated. In some embodiments, the prioritized AID routing table includes some or all of the information that is also in the conventional routing table. In other embodiments, the prioritized AID routing table includes a subset of the information that is in the conventional routing table. In this way, the prioritized AID routing table co-exists with a conventional routing table such that transactions received by the secure wireless circuit are first processed in association with information in the prioritized AID routing table.

The prioritized AID routing table may be loaded by an STK application stored in a security module that also includes the secure wireless circuit. For each secure transaction that is initiated through the secure wireless circuit, the prioritized AID routing table is interrogated, and one or more entries corresponding to an AID in the secure transaction are identified. Based on the priority of the identified entries, the transaction is passed to the selected function for handling. In some cases, transactions are passed to applications running within the security module, and in other cases, transactions are passed to applications running outside of the security module.

A method to prioritize secure transactions may be summarized as including initializing a communication path to a secure wireless interface circuit of a mobile device; providing priority table information, the priority table information including application identifiers and links to processor executable software functions associated with the application identifiers, at least one of the processor executable software functions stored in a security module wherein the at least one of the processor executable software functions stored in the security module is prioritized over a corresponding processor executable software function executable outside of the security module; and loading a priority table in the secure wireless interface circuit with the priority table information passed over the communication path. The at least one of the processor executable software functions stored in the security module may be prioritized over the corresponding processor executable software function executable outside of the security module in an act that includes sorting the priority table information. The at least one of the processor executable software functions stored in the security module may be prioritized over the corresponding processor executable software function executable outside of the security module in an act that includes adding a variable priority number to the priority table and associating the variable priority number with the at least one of the processor executable software functions stored in the security module. The security module may be a subscriber identity module (SIM) card, the mobile device may be a smartphone, and the secure wireless interface circuit may conform to a near field communication (NFC) architecture. The communication path may be formed between the security module and the secure wireless interface circuit of the mobile device. The communication path may be formed between a remote computing device and the secure wireless interface circuit of the mobile device via a host-card-emulation (HCE) interface.

The method may include initializing a subscriber identity module toolkit (STK) function in the security module of the mobile device; and executing the STK function to provide the priority table information.

The method may include receiving a transaction via the secure wireless interface circuit; parsing the transaction to retrieve an application identifier (AID); and retrieving from the priority table, based on the AID, information representing a function to execute, wherein the function to execute is either stored on the security module or stored on a remote computing device.

The method may include directing execution of the function to execute via a host-card-emulation (HCE) interface.

The method may include directing execution of the function to execute via a host-card-emulation (HCE) interface; and activating an executable function associated with the priority table via a user interface of the mobile device.

A security module may be summarized as including a secure wireless interface circuit; and a memory associated with the secure wireless interface circuit, the memory arranged to store a priority table, the priority table configured to store: a plurality of application identifiers; links to processor executable software functions associated with the application identifiers, at least a first one of the processor executable software functions stored in the security module and at least a second one of the processor executable software functions executable outside of the security module; and information to prioritize either the first one of the processor executable software functions or the second one of the processor executable software functions. The security module may be a subscriber identity module (SIM) card. The security module may be associated with a smartphone. The secure wireless interface circuit may conform to a near field communication (NFC) architecture. The memory may be arranged to store a subscriber identity module toolkit (STK) application that directs operations of the security module associated with the priority table.

A non-transitory computer-readable storage medium whose stored contents configure a computing system to perform a method may be summarized as including initializing a subscriber identity module toolkit (STK) function in a security module of a mobile device; executing the STK function, the executing causing acts including: initializing a communication path between the security module and a secure wireless interface circuit; loading a priority table with application identifiers, links to processor executable software functions associated with the application identifiers, and prioritization information indicating a priority of at least one first application identifier over at least one second application identifier. A first one of the processor executable software functions may be stored in the security module and a second one of the processor executable software functions may be executable outside of the security module. The first one of the processor executable software functions stored in the security module may be prioritized over the second one of the processor executable software functions executable outside of the security module.

The non-transitory computer-readable storage medium whose stored contents configure the computing system to perform the method may further include receiving a transaction via the secure wireless interface circuit; parsing the transaction to retrieve an application identifier (AID); and retrieving from the priority table, based on the AID, information representing a function to execute, wherein the function to execute is either stored on the security module or stored on a remote computing device.

The non-transitory computer-readable storage medium whose stored contents configure the computing system to perform the method may further include attempting to execute one or another of the function to execute that is stored on the security module and the function to execute that is stored on the remote computing device; and if the one function to execute is not executed, attempting to execute the other function to execute.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1A illustrates a particular payment landscape;

FIG. 1B illustrates the payment landscape of FIG. 1A in more detail;

FIG. 2 illustrates a more recent payment landscape that is becoming available;

FIG. 3A illustrates security-card-based communication of secure data through a mobile network;

FIG. 3B illustrates a host-card-emulation-based communication of secure data through a mobile network;

FIG. 4 illustrates another embodiment with an improved architecture over the infrastructures illustrated in FIGS. 3A and 3B;

FIG. 5 is a prioritized AID routing table embodiment; and

FIG. 6 is a flowchart that represents acts of prioritizing applications in a security module embodiment.

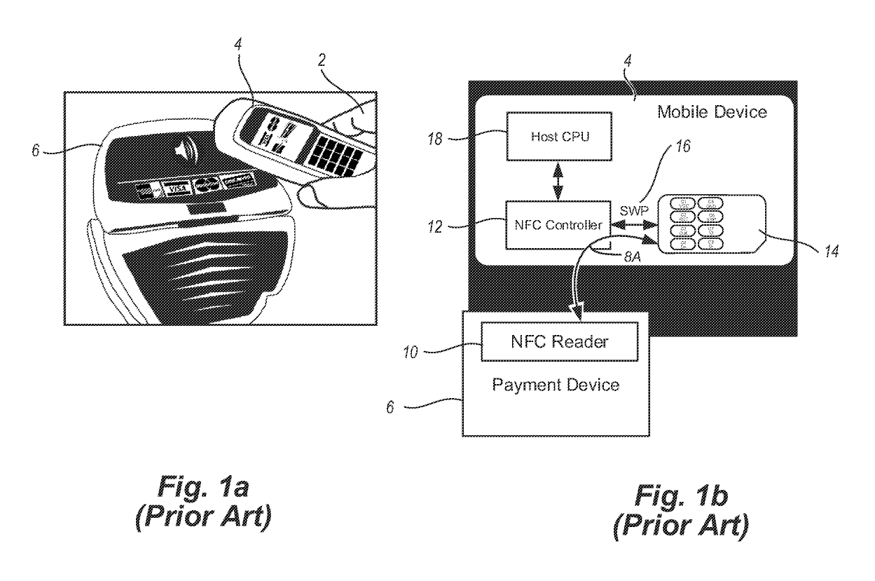

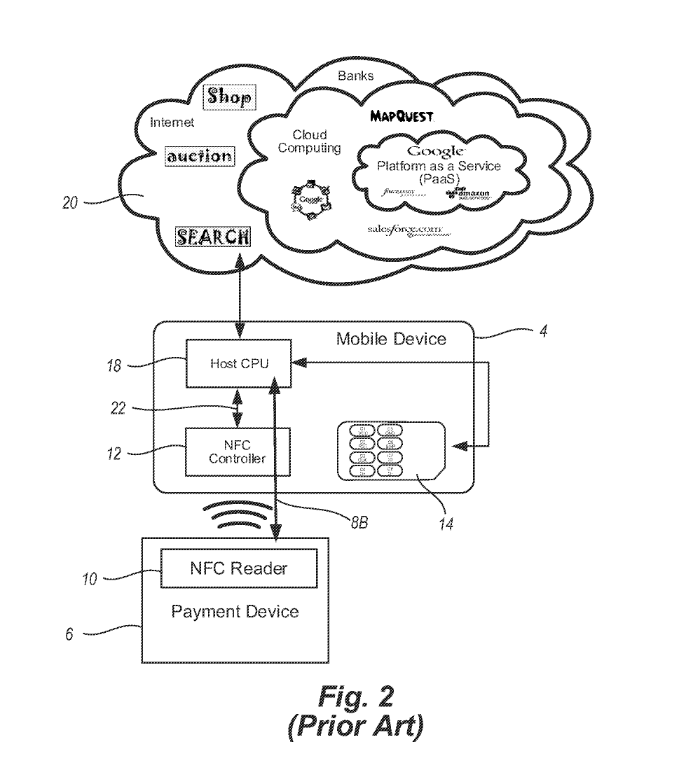

### DETAILED DESCRIPTION

The disclosure herein describes processes, machines, and articles of manufacture that service vast multitudes of users and improve the functioning of computing devices and systems where embodiments of those devices are operating. When using these devices, mobile network operators (MNO), also known as mobile network service providers, can add value to their existing offerings by prioritizing where certain secure operations are handled: within a security module (e.g., a SIM card) or through a host processor and wirelessly accessed remote services.

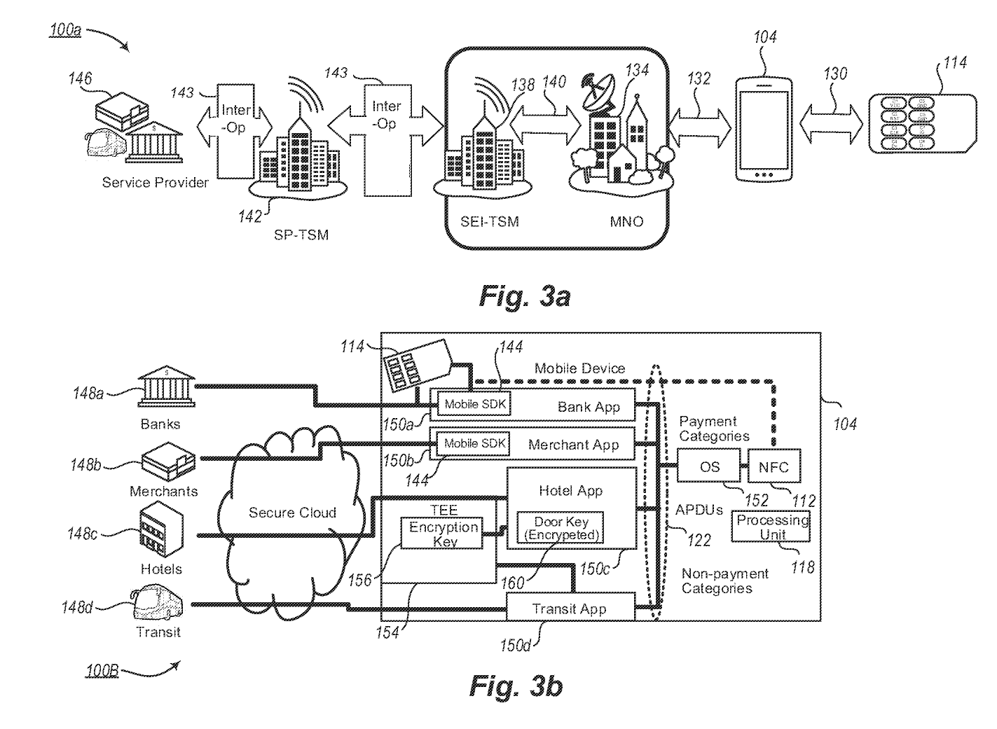

FIG. 3A illustrates security-card-based communication of secure data through a mobile network 100A. The embodiments of mobile systems that prioritize an application identifier (AID) routing table are compatible with the security-card-based communication architecture of FIG. 3A. Nevertheless, the security-card-based communication architecture of FIG. 3A is first described prior to a discussion of prioritized AID routing table embodiments. From the discussion of FIG. 3A, skilled artisans will better appreciate how prioritized AID routing table embodiments operate within security-card-based communication architectures.

In FIG. 3A, a secure communications infrastructure includes a security module 114 such as a SIM card coupled to a mobile device 104 such as a smartphone. The mobile device has a direct communicative relationship 130 with the security module 114. The communications may occur via a single wire protocol (SWP) bus, an 120 bus, serial peripheral interface (SPI) bus, or some other communication path and protocol.

The mobile device 104 in FIG. 3A is illustrated as a smartphone, but other devices are contemplated. For example, mobile device 104 may be embodied as a tablet computing device, a laptop computer, a multimedia device, exercise equipment, or in some other form. The mobile device 104 may be any computing device that is arranged to wirelessly communicate 132 over a wide area wireless network such as a cellular network that conforms to a 3G, 4G GSM protocol, long term evolution (LTE) protocol, a 5G protocol, or some other wireless communication network protocol. Typically, the wide area wireless network is administered by a network service provider 134, which is also called a mobile network operator (MNO).

The mobile device 104 communicates with the MNO 134 that provides the wireless mobile network services. The MNO 134 is closely aligned with data in the security module 114 and, most often, the MNO 134 provisions the initial data into the security module 114. Generally speaking, in communication sessions (e.g., phone calls, electronic mail, text messages, and the like) where the mobile device accesses services are provided by the MNO 134, information from the security module 114 is passed to the MNO 134.

A secure element issuer-trusted service manager (SEI-TSM) 138 provides cryptographic tools and data 140 such as public and private keys and encryption/decryption algorithms to the MNO 134 and other entities, some of which are associated with the MNO 134. A second trusted service manager coupled with a service provider (SP-TSM) 142 is separated from the SEI-TS by an optional interoperability facilitator 143. The interoperability facilitator 143 permits the sharing of disparate data structures, protocols, and the like between trusted service managers and other computing devices. The SP-TSM 142 is coupled through a same or different interoperability facilitator 143 to one or more service providers 146.

FIG. 3B illustrates a host-card-emulation-based (HCE-based) communication of secure data through a mobile network 100B. As in the foregoing discussion of FIG. 3A, embodiments of mobile systems that prioritize an application identifier (AID) routing table are also compatible with the HCE-based communication architecture of FIG. 3B. The HCE-based communication architecture of FIG. 3B is now described prior to a discussion of prioritized AID routing table embodiments so that those of skill in the art can better appreciate how prioritized AID routing table embodiments operate within HCE-based communication architectures.

In FIG. 3B, the mobile device 104 embodiment includes a security module 114 that is accessed in cooperation with the transfer of secure data between a mobile device 104 and particular service providers. For example, a mobile software development kit (SDK) 144 provides an application programming interface (API) that can be used to communicate secure data to and from the security module 114 and a certain banking financial institution 148a. The mobile SDK 144 is accessed through a particular software application represented in FIG. 3A as a Bank App 150a. A particular set of application protocol data units (APDU's) are used to control and direct the Bank App 150a.

Also within the mobile device 104, an operating system (OS) 152 is executing under the control of a processing unit 118. The operating system 152 provides an interface to a secure wireless circuit, which is illustrated in FIG. 3B as near field communication (NFC) controller circuitry 112. The OS 152 also provides an interface and operating environment for a set of software program applications, including the Bank App 150a.

The applications administered by the operating system 152 are characterized as payment categories and non-payment categories, but other groups and designations are contemplated and not discussed herein.

In addition to the Bank App 150a, a second payment application is a Merchant App 150b. The Merchant App 150b includes another mobile SDK 144 and facilitates payment for goods and services provided by various merchants 148b. In some cases, the merchants 148b provide their own proprietary secure services, but in other cases, the many entities share a common set of services.

FIG. 3B also illustrates two more non-limiting applications, a Hotel App 150c and a Transit App 150d. Many other applications (not shown) are also considered. The Hotel App 150c and Transit App 150d use a particular encryption engine operating in a trusted execution environment 154, and one or more encryption keys 156 are used to pass secure data. A secure cloud infrastructure 160 provides a communication medium and framework for securely passing data and control signals to remote destinations such as the illustrated transit station 148d, hotel 148c, and merchant 148b.

The applications presented in the mobile device 104 are provided using a host card emulation (HCE) interface 122. APDUs are used within the HCE interface 122 to communicate data and control signals. The applications shown on the left side of the operating system provide secure data transfer functionality while the NFC controller 112 on the right side recognizes a smart card interface.

As mentioned previously, the infrastructure illustrated in FIG. 3B is, in some cases, supplanting the infrastructure of FIG. 3A. It has been recognized, however, that completely eliminating the infrastructure illustrated in FIG. 3A is undesirable.

In the HCE-based communication of secure data through a mobile network 100B configuration, applications are coupled to cloud-based resources. The cloud-based resources have access to data communicated through an NFC controller or some other secure wireless interface. The cloud-based resources can provide desirable functionality. For example, digital wallet applications can be moved to a cloud-based system and accessed with the mobile device 104 or with some other device. On the other hand, the HCE configuration is also limited to power-on circumstances. That is, under an HCE scenario, the mobile device 104 must be powered on and communicatively coupled to the Internet or some other network infrastructure in order for the transaction to occur. Conversely, a simpler architecture wherein applications securely pass data between the NFC controller and the security module as in FIG. 3A can be operative even when the mobile device is not powered.

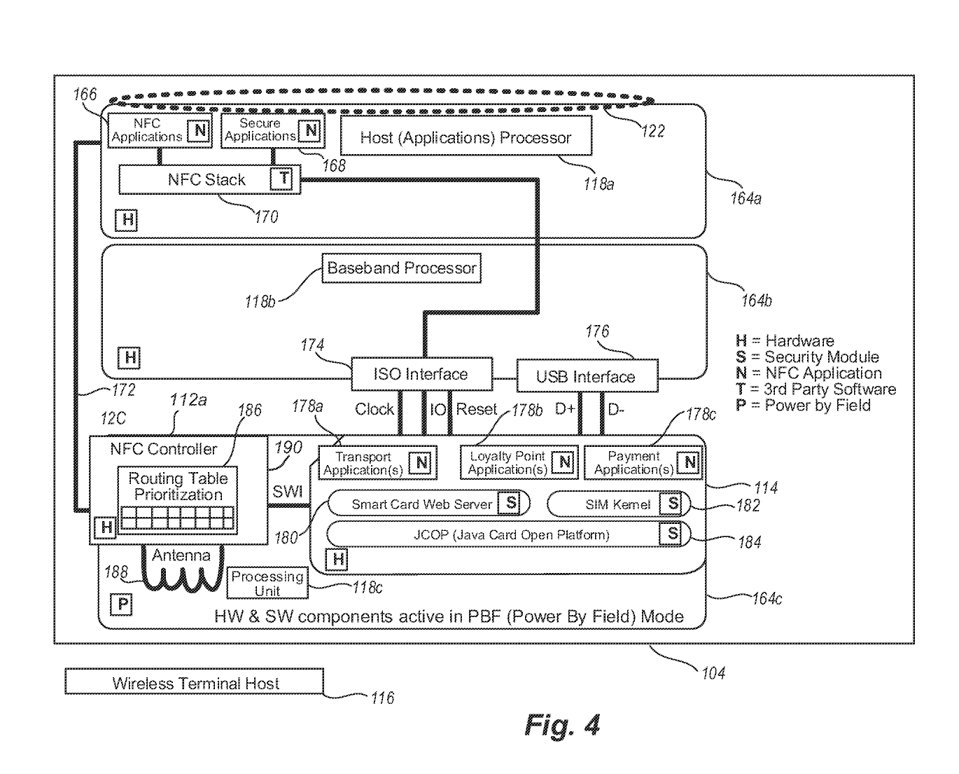

FIG. 4 illustrates another embodiment with an improved architecture over the infrastructures illustrated in FIGS. 3A and 3B. The improved architecture also avoids the undesirable characteristics of embodiments that require the mobile device 104 to have sufficient power and remote network connectivity. As discussed herein, the improvements are facilitated via a prioritized AID routing table 186 arranged in association with secure wireless interface circuitry 112a.

FIG. 4 is a block diagram of various mobile device 104 modules. Different blocks are designated as “H” for hardware circuitry, “S” for a security module, “N” for a wireless security module application, “T” for third-party software, and “P” for circuitry that is powered by the electromagnetic field of a wireless remote device. Other features, including hardware, software, mechanical interfaces, and the like, are not shown for simplicity.

Within the mobile device 104, a host processor 118a, also known as an applications processor, is located on a first portion of a substrate such as a circuit board 164a of the mobile device 104. A baseband processor 118b is located on a second portion of the substrate such as a circuit board 164b of the mobile device 104, and a security processor 118c is located on a third portion of the substrate such as a circuit board 164c of the mobile device 104. The different portions of the substrate may be shared and formed on a single substrate (e.g., a single circuit board), or one or more portions may be formed on separate substrates. In some cases, the portions are formed on semiconductor substrates as one or more integrated circuits using known semiconductor processes.

The host card emulation (HCE) interface 122 is managed by the host processor 118a. In this way, the host processor 118a carries out HCE interface 122 operations as described with respect to FIG. 3B. The host processor 118a also manages other functions of the mobile device 104. For example, the host processor 118a may direct any or all of the mobile device 104 features including user interface features, third party-software, memory utilization, battery functions, phone-book and other user communication interface features. In addition, the host processor 118a may direct operations of the baseband processor 118b, the security processor 118c, the security module 114 operations, and the like. The third party software directed by the host processor 118a may include a browser for Internet usability, games, media codecs, and the like. The host processor 118a, baseband processor 118b, and security processor 118c may be formed as a single processor, two or more processors, or in some other configuration.

Circuit board 164a is also illustrated with various software applications including security module (e.g., NFC) application(s) 166, secure application(s) 168, and a security module (e.g., NFC) stack 170. In some cases, the security module software 166 of circuit board 164a can directly access the secure wireless interface circuitry 112a (e.g., NFC controller) of the mobile device 104 via a dedicated control and data bus 172. The dedicated control and data bus 172 is shown in FIG. 4 as an 120 bus, but other bus architectures and protocols are contemplated. In other cases, the security module software 166 of circuit board 164a indirectly accesses the security module 114, including the secure wireless interface circuitry 112a, via a secure stack 170 and through a first security module interface 174. The first security module interface 174 in FIG. 4 is shown as an International Organization for Standardization (ISO) bus such as ISO/IEC 7816, but other interface architectures and protocols are contemplated.

A second security module interface 176 is illustrated in FIG. 4 as a Universal Serial Bus (USB) interface.

The security module 114 of the mobile device 104 in FIG. 4 includes several hardware circuits and software routines that can be powered by an externally produced electromagnetic field from a wireless terminal host 116. The security module 114 also includes access to other power sources available in the mobile device 104, which may be produced, for example, by a battery (not shown). In addition, the security module 114 can also operate when the mobile device power is not available.

In FIG. 4, the security module 114 (e.g., a subscriber identity module (SIM) card) is illustrated as having one or more transport applications 178a, one or more loyalty point applications 178b, and one or more payment applications 178c. The security module 114 may also have executable programs to access mobile network services, programs to carryout financial transactions, and programs to interact with external entities. Other software applications (not shown) may also be included. The security module 114 is further illustrated with a smart card web server 180, a SIM kernel 182, and a Java card open platform application 184. Memory, interface logic, and other features of the security module 114 are not shown for simplicity.

The mobile device 104 of FIG. 4 includes secure wireless interface circuitry 112a. In the embodiment of FIG. 4, the secure wireless interface circuitry 112 may be a near field communication (NFC) controller 112, but other interfaces are contemplated. For example, the secure contactless interface may have underlying radio frequency identification (RFID) logic, Bluetooth logic, low energy Bluetooth (BLe) logic, IEEE 802.11 (WiFi) logic, or some other like infrastructure. In some cases, the underlying logic conforms to parameters established by a standard setting body. In other cases, the underlying logic conforms to a proprietary interface.

The secure wireless interface circuitry 112a includes, or is otherwise associated with, a prioritized AID routing table 186, also called an application identifier (AID) prioritization table. Generally, the prioritized AID routing table 186 directs the secure wireless interface circuitry 112a to execute particular software routines with particular parameters based on particular inputs that are received. For example, when a wireless terminal host 116 such as a payment device is proximate to the mobile device 104, an electromagnetic field (EMF) is sensed by an antenna 188. The EMF produces power for the security module 114 and communicates data via the secure wireless interface circuitry 112a. If the data suggests that a secure transaction (e.g., a secure mobile payment process, an access request for a personal identification number (PIN), a request to access or store health records, or the like) has been initiated, one or more entries in the prioritized AID routing table 186 will direct operations either within the security module 114 or through the host processor 118a. Accordingly, the action taken when the secure wireless interface circuitry 112a is activated can be configured and prioritized within the security module 114. This feature permits a mobile network services provider (MNO) 134, a security module 114 provider, a secure wireless interface circuitry 112a manufacturer, a different authorized entity, or some combination of these entities to efficiently and securely control how secure transactions on the mobile device 104 will be handled.

The association of the prioritized AID routing table 186 with the secure wireless interface circuitry 112a provides a mechanism under which handling of every secure transaction is first directed by entries in the prioritized AID routing table. Accordingly, even if other AID routing tables are arranged in the mobile device, the secure transaction may or may not be subject to information in the other AID routing tables.

For example, in some embodiments, an AID routing table is stored on circuit board 164a or in some other location controlled by the host processor 118a. If an entry in the prioritized AID routing table 186 instead directs processing of the secure transaction by a function on the security module 114, then the host processor 118a may never be made aware of the transaction. Alternatively, if the prioritized AID routing table 186 does not have an entry for an AID or if the prioritized AID routing table 186 otherwise passes the secure transaction through to an HCE interface 122, then the routing table controlled by the host processor 118a (e.g., stored on the circuit board 164a) will direct the processing of the secure transaction. In this way, routing tables stored elsewhere in the security module 114, routing tables stored in cooperation with an HCE-interface 122, routing tables controlled by other processors, and other routing tables not necessarily discussed herein are all subservient to the entries in the prioritized AID routing table 186.

The SIM kernel 182 in the security module 114 directs the operations of the processing unit 118c in the security module 114. The SIM kernel 182 is a secure software application running on the mobile device 104, which directs operations of the security module 114. The SIM kernel 182 includes or otherwise instantiates a subscriber identity module (SIM) Application Toolkit function, also known as a SIM Toolkit function or, commonly, an STK function or STK application. The STK is a GSM standard system that enables the security module 114 to initiate actions through STK-base applications, which can be used by a mobile device 104 and a mobile network service provider 134 to provide various value-added services.

The STK application is represented by one or more processor executable commands programmed into the security module 114 (e.g., the SIM), which define how the security module 114 will interface with devices inside and outside of the security module 114. The STK application can operate independent from the host processor 118a and the baseband processor 118b. As described herein, the STK application can also operate when the mobile device 104 has a “dead” battery by using power derived from an EMF via the contactless interface,

STK software applications permit the security module 114 to initiate, manage, control, or otherwise direct mobile network operations, security operations, display menus, user input (e.g., keypad, touchscreen, audio commands, and the like), and other operations of the mobile device.

In many cases, the STK application is a single application resistant to hackers. Multiple functional “applets” may be included in an STK application to provide expanded utility. In many cases, the STK application begins executing when the mobile device 104 first power's up. The STK application operates in the secure environment of the security module 114.

In the embodiment of FIG. 4, when the mobile phone 104 boots up, the security module 114 will also boot up. An STK application will request initialization of a communication bus 190 between the security module and the secure wireless interface circuitry 112a. Communication bus 190 is shown as a single wire interface (SWI) bus, though other architectures and protocols are considered. The initialization of the communication bus 190 may be enabled by default, performed by the host processor 118a, or by some other means. In some embodiments, 3GPP standard commands, called class “I” commands, are available.

In this embodiment, after the communication path is established, an STK application on the security module 114 will direct the download or population of a prioritized AID routing table 186 associated with the secure wireless interface circuitry 112a. The data for the prioritized AID routing table 186 may be preconfigured and stored in the security module 114; the data may be generated based on particular conditions, such as a key press sequence or configuration, of the mobile device 104; the data may be loaded during an update phase to the security module 114, or the data may be produced and available via some other mechanism.

In some embodiments, a variety of actions may be performed when various conditions are presented to the secure wireless interface circuitry 112a. For example, when secure transactions can be performed by either the security module 114 or by a remote computing device accessed through the host card emulation (HCE) interface 122, then either the security module 114 or the host processor 118a will be given priority to carry out the transaction through the HCE interface 122. In the event the prioritized mechanism is unable to complete the transaction, then another mechanism can be used.

This type of prioritized solution is compatible with, and does not violate, known standards of cellular operations, for example 3GPP standards. Instead, the disclosure herein provides additional features added on to the features already available to a mobile device 104. In some cases, access and use of the routing table 186 is transparent to other operations of the mobile device 104 and to the mobile network service provider 134. Furthermore, the solution described herein is compatible with nearly any mobile device. That is, the prioritized AID routing table 186 can be programmed during or after manufacture of the mobile device 104, and the prioritized AID routing table 186 can be specifically programmed to pass along any tests of secure wireless interface circuitry 112a which require action through the host processor 118a. Beneficially, however, the routing table prioritization feature provides additional functionality for the mobile device 104.

A first scenario is now described wherein preference in the prioritized AID routing table 186 is given to host-card-emulation-based responses when the secure wireless interface circuitry 112a is activated. In this scenario, when the mobile device 104 boots up, after a near field communication execution environment (NFCEE) discovery process is executed, all application identifiers (AIDs) are populated in an NFC controller's prioritized AID routing table 186 and, in some cases, any other routing table of the mobile device. After the prioritized AID routing table 186 is populated, the table may be sorted or otherwise manipulated to prioritize secure transactions for handling through the HCE interface 122. This prioritization process may include entries in the prioritized AID routing table 186 that pass along secure transactions having certain AIDs, or this process may include simply duplicating information from a different routing table in the prioritized AID routing table 186. Other mechanisms may also be used. Thereafter, for any transaction, when the secure wireless interface circuitry 112a receives input, the prioritized AID routing table 186 will direct the operation to be passed through the host processor 118a and the HCE interface 122. That is, during a secure wireless transaction, the AID that is retrieved from the transaction is looked up in a populated prioritized AID routing table 186, and the transaction is either passed along to the HCE interface 122 for processing via another routing table, or the HCE application associated with the AID is directly accessed from a remote Secure Element (SE) such as the banking institution 148a (FIG. 3B), a merchant 148b (FIG. 3B), or some other secure remote computing device. In this scenario, a host computing emulation (HCE) interface 122 can be used to control and determine the routing of selected AID commands. In this scenario, the communication bus 190 (e.g., SWI data path) may not be needed, and the security module 114 may not be needed to store secure data.

In a second scenario, the host processor 118a and the HCE interface 122 continue to operate as they did in the first scenario. The difference in the second scenario is that an STK application running on the security module 114 controls and initializes data in a prioritized AID routing table 186 to direct handling of a secure transaction within the security module 114. This flexible solution is preferred because the prioritized AID routing table is closely associated with the secure wireless interface circuitry 112a. Thus, the security module 114, which can be carefully controlled and not easily compromised, is in charge of secure transaction processing, and the secure module 114 can be programmed to either act on a secure transaction or permit another function that is internal or external to the mobile device to act on the secure transaction. This solution can be seamless, unobtrusive, and transparent to the user of the mobile device 104.

In the embodiment of FIG. 4, a buffer (e.g., the prioritized AID routing table 186) is implemented by the secure wireless interface circuitry 112a to take the communication from the security module 114 and populate a list of AIDs, which the security module 114 selects for prioritization. The selections can be driven by a mobile network operator (MNO) 134, a secure wireless interface circuitry manufacturer, a security module provider, or in some other way. That is, the STK application on security module 114 may in some embodiments be programmed to take direction from nearly any authorized source regarding entries in the prioritized AID routing table 186. Then, when the prioritized AID routing table 186 is enabled, the secure wireless interface circuitry 112a first checks an incoming AID retrieved from a secure wireless transaction against the security module allocated entry in the prioritized AID routing table 186 before interrogating an entry in any other routing table allocated by the host processor 118a. If the AID is not handled by the prioritized AID routing table 186 stored in the security module 114, then the entry in the routing table populated by the host processor 118a is interrogated. In this way, even if a mobile device maker later moves the AID populated routing table 186 into a memory controlled by the host processor 118a, or some other location accessible to the host processor 118a, the present solution acts as a filter of the applications because they are governed by the prioritized AID routing table 186 in the secure wireless interface circuitry 112a that has been directed by the security module 114.

Another benefit of the solution described in the present disclosure is the added security provided. When a prioritized AID routing table 186 is prioritized, sorted, or otherwise loaded as described herein, the solution is only operative when a certain STK application is executed. The certain STK application is only present on security modules provided by authorized mobile network operators, security module providers, and the like.

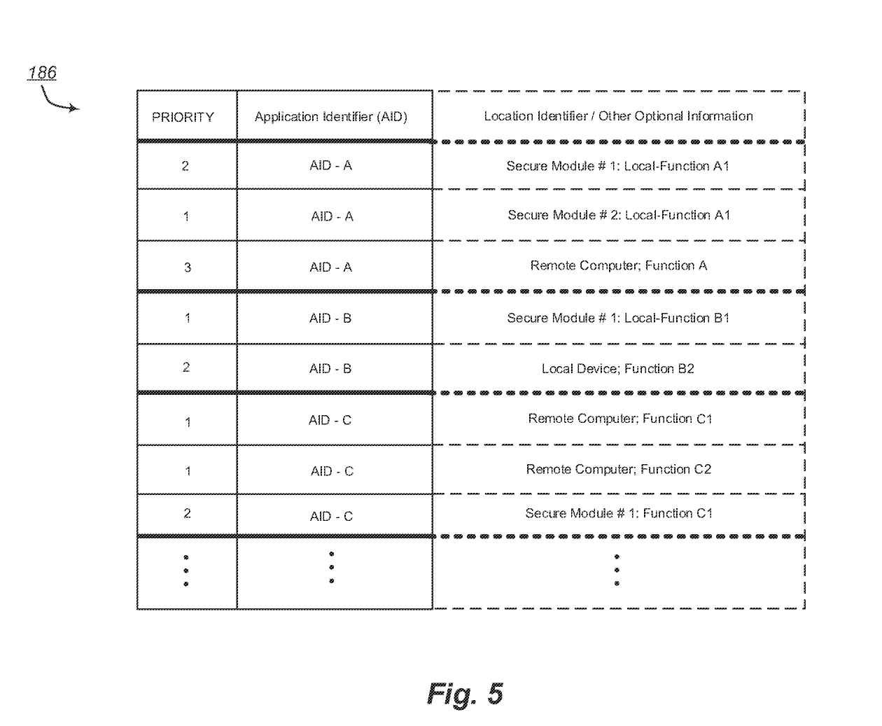

FIG. 5 is a prioritized AID routing table 186 embodiment. The embodiment is non-limiting and provided to illustrate one way in which a prioritized AID routing table 186 may be arranged. The prioritized AID routing table 186 of FIG. 5 is stored in, or otherwise associated with, the secure wireless interface circuitry 112a. For example, in one embodiment, the prioritized AID routing table 186 is stored in a memory adjacent to the secure wireless interface circuitry. In another embodiment, the prioritized AID routing table 186 is stored in a dedicated area of security module 114 or in a memory where one or more STK applications are stored. In still other cases, the prioritized AID routing table 186 is stored in a separate and distinct memory, such as a dongle, a memory card, or some other memory.

In the prioritized AID routing table 186 embodiment of FIG. 5, the table is organized into rows and columns wherein a first row represents priority, a second row represents an application identifier (AID), and a third column represents a location identifier. Other optional information may be included in the third column or in other columns. Each row of the prioritized AID routing table 186 represents a priority, a location identifier, and other optional information associated with a respective AID. Of course, other embodiments of the prioritized AID routing table 186 may have different organizational structure and information.

As is known to one of skill in the art, an application identifier (AID) has traditionally been used to address a software application stored in a security module 114. Recently, AIDs have also been used to address software applications stored in other locations. For example, in some cases, an HCE interface is exposed to the secure wireless interface circuitry 112a as if the HCE interface was another security module. In this way, when an AID addresses a particular software application, the HCE interface executes a remote software routine.

An exemplary definition and use of one particular AID implementation is set forth in an organized standard identified as ISO/IEC 7816, which is administered by the International Organization for Standardization (ISO) and the International Electrotechnical Commission (IEC). According to the standard, the AID is coded using up to 16 bytes of data, and the AID is generally represented in hexadecimal notation. The most significant nibble (i.e., 4 bits) of the AID indicates a registration category such as International Registration, National Registration, Proprietary non-registration, and others. The subsequent 36 bits form a registered application provider identifier (RID). Following these first five bytes of the AID, up to eleven more bytes are used to define a proprietary application identifier extension (PIX) or a proprietary application identifier, which indicates a particular software application that is associated with the AID.

In view of the non-limiting AID described herein, one of skill in the art will recognize that when an AID is passed in a secure transaction, the conventional secure wireless circuitry can parse the AID and instantiate an application expressly associated with the AID. Conversely, with respect to FIG. 5, one of skill in the art will recognize that when an AID is in a secure transaction, the secure wireless interface circuitry 112a (FIG. 4) can parse the AID, locate one or more corresponding AIDs in the prioritized AID routing table 186, and take other appropriate action.

As discussed herein, action taken by secure wireless interface circuitry 112a is broadly understood to include actions taken by the secure wireless interface circuitry 112a, actions taken by an associated STK application, actions executed by processing unit 118c, and other actions.

In some cases, the appropriate action taken by the secure wireless interface circuitry 112a may include instantiating an application expressly associated with the AID in the same way that a conventional secure wireless circuitry performs. Thus, it is shown that devices that implement a prioritized AID routing table 186 can seamlessly perform just as a convention device with a conventional routing table. Alternatively, devices that implement a prioritized AID routing table 186 may also provide additional desirable features.

Turning to FIG. 5, the identified AID values that are illustrated (i.e., AID-A, AID-B, AID-C) may be any particular AID having up to 16 bytes as described herein with respect to ISO/IEC 7816. Alternatively, the identified values may be structured in other ways without departing from the teaching of the present disclosure.

In the prioritized AID routing table 186 of FIG. 5, a particular AID-A is stored in three rows of the prioritized AID routing table 186. Each of the three rows has a different priority value and a different location identifier value. A first instance of AID-A is assigned priority value “2,” a second instance of AID-A is assigned priority value “1,” and a third instance of AID-A is assigned priority value “3.” When a secure transaction received by the secure wireless interface circuitry 112a includes AID-A, the secure wireless interface circuitry 112a will interrogate the prioritized AID routing table 186, locate the row or rows where AID-A is stored, recognize which row has a “highest” priority, and instantiate an appropriate application, such as the application stored in the third column. If for one reason or another, the first selected application with the highest priority is unavailable or fails, the secure wireless interface circuitry 112a may instantiate the application associated with the “second highest” priority. Along these lines, the application associated with a next highest priority may be instantiated each time a higher priority application fails or otherwise does not complete.

It is recognized that many different priority schemes may also be implemented. For example, in some embodiments, a highest priority application is always instantiated when a particular AID is received. In other embodiments, a weighted priority, a round-robin scheme, or some other mechanism may be used to select which function will be instantiated.

In the first three AID rows of the prioritized AID routing table 186 in FIG. 5, applications are recognized as stored locally in a first secure module or a second secure module, or the application is stored on a remote computer. One scenario where this type of environment may be used is when a mobile device has two secure modules. In one secure module, secure information associated with a first MASTERCARD credit account is stored, and in a second secure module, secure information associated with a second MASTERCARD credit account is stored. Secure information associated with a MASTERCARD credit account may be stored on a remote computer. When a user of the mobile device makes payment using the mobile device, the user may execute a certain STK function and indicate payment with MASTERCARD. When the secure transaction is conducted, the secure wireless interface circuitry 112a will first try to complete the transaction using secure information stored on Secure Module #1. If the transaction cannot be completed, the secure wireless interface circuitry 112a will try to complete the transaction using secure information stored on Secure Module #2, and so on if the transaction still cannot be completed. In this way, seamlessly to the user, the transaction has a higher likelihood of success without any further user intervention.

In the fourth and fifth rows of the prioritized AID routing table 186 of FIG. 5, two other applications are associated with AID-B. In this case, the secure transaction that includes AID-B will attempt to instantiate a Local Function B1 stored on a Secure Module #1. If the transaction cannot be completed, the secure wireless interface circuitry 112a will instantiate a Local Function B2 that is stored somewhere else on the mobile device. One scenario for these entries may include a particular pre-paid account. When insufficient pre-paid funds are available to complete a transaction, which is indicated by failure of the Local Function B2, an insecure application on the device, Local Function B2, is instantiated to call immediate attention to the mobile device user or to take some other action.

Another scenario for the fourth and fifth rows may involve a mobile network operator (MNO). The MNO may provide feature-rich services to particular customers based on a level of contracted services, a location, time of day, network congestion, a contest, or for some other reason. In this way, when the user is in a particular business at a particular time or day, or for some other reason, a particular secure transaction may be permitted; and in other cases, an application on the local device is instantiated. The insecure local device application may engage the user, send un-encrypted data, or perform some other function.

In yet another scenario, a maker of a particular mobile device, or a maker of software for mobile devices, or some other business entity may similarly allow secure transactions in some environments, and may alternatively instantiate an insecure application in another case. If, for example, a mobile device maker also has retail business locations, certain mobile devices may perform certain secure transactions when the device is used in the retail business location, but in other cases, the secure transaction will fail and instead another local application will be executed.

The sixth, seventh, and eighth rows of the prioritized AID routing table 186 in FIG. 5 are illustrated with two AID-C entries having a same priority “1.” This shared priority is permitted in some embodiments. In this case, the secure wireless interface circuitry 112a will select which application from which AID-C row is instantiated. The secure wireless interface circuitry 112a may select the row based on least recently used (LRU), a round-robin scheme, a time of day, or in any other way. In this way, a transaction has a higher chance of successful completion. In one scenario, a remote service provider administers secure information in a cloud-based architecture. The remote service provider may provide multiple remote server addresses wherein functions can be performed, but in order to provide load-balancing, more reliable service, or for some other reason, the remote service provider may include multiple entries in the prioritized AID routing table 186, each one having a same priority.

As discussed, priority table information may be provided to the secure wireless interface circuitry 112a for loading in the prioritized AID routing table 186 by an STK application stored in the security module 114, by a remote computing device administered by an MNO or some other authorized entity, by a security module manufacturer or distributor, or by some other means. In many cases, the prioritized AID routing table 186 is loaded when the mobile device 104 boots up. In other cases, the prioritized AID routing table 186 may be loaded by a key sequence, touch screen action, or some other user input to the mobile device 104 after the mobile device 104 is booted up.

Priority information in the prioritized AID routing table 186 may be dynamically adjusted. For example, in some embodiments, when the secure wireless interface circuitry 112a detects one or more multiple failures of a particular application, the secure wireless interface circuitry 112a may automatically adjust the priority of certain entries. In other embodiments, an MNO, a financial institution, or some other entity may force a change in priority based on a consumer's lack of payment, a change in user equipment or network infrastructure, a discovered security flaw, or for another reason. In these cases, the MNO or other entity may securely load or otherwise execute an STK application that re-sorts the prioritized AID routing table 186. In some cases, sorting or otherwise adjusting priority in the prioritized AID routing table 186 may include changing entries in the “Priority,” column, moving rows of information to increase table search speed, or some other mechanism.

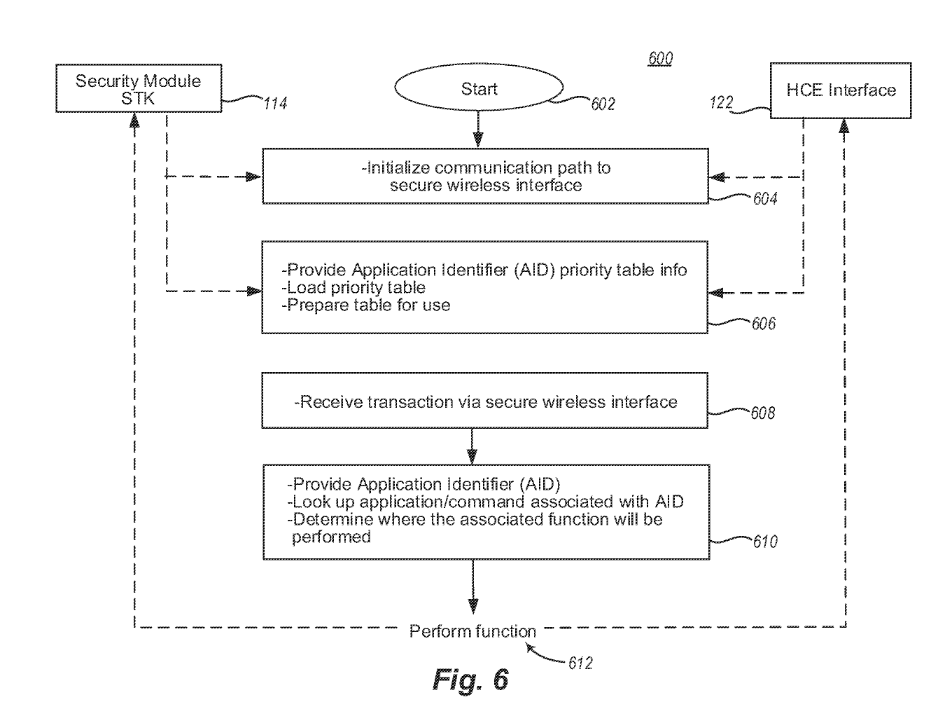

FIG. 6 is a program flow 600 that represent acts of prioritizing applications in a security module embodiment. The security module (e.g., a SIM card) is associated with a mobile device such as mobile device 104 of FIGS. 3B and 4. In the flowchart, selected acts are represented as performed in a security module 114, and in particular by a subscriber identity module (SIM) toolkit application or “STK application” stored in the security module 114. Other acts are represented as performed by a remote computing device that is communicatively coupled to the mobile device 104 through a host card emulation (HCE) interface 122. In the program flow 600, processing begins at 602.

At 602, the mobile device 104 may be powering up. Alternatively, the mobile device be operating and in any known state such as “awake,” “sleep,” “deep sleep,” or some other state. In some embodiments, the program flow begins at 602 when a user performs a particular input sequence such as a keypress sequence or touch screen action on the mobile device 114. In other embodiments, program flow begins at 602 when a particular transaction is initiated via the secure wireless interface circuitry 112a, and in still other embodiments, program flow begins at 602 when a predetermined command is received via the HCE interface 122. Other events may also cause program flow to begin at 602.

At 604, a communications path is initialized between a source device and the secure wireless interface circuitry 112a (e.g., an NFC controller 112). The source device may be either the security module 114 or the secure wireless interface circuitry 112a. Accordingly, the path may be formed between the security module 114 and the secure wireless interface circuitry 112a, or the path may be formed between the HCE interface 122 and the secure wireless interface circuitry 112a.

Optional communication path initiation is illustrated in the program flow 600 via dashed lines originating at a source device and terminating at certain acts such as the acts at 604 and 606. Even though the information flow is illustrated as uni-directional, it is recognized that communications may be bidirectional. One device, for example, may initiate communications, and another device may respond. Similar bidirectional communications may occur throughout program flow 600 even when single-arrow lines are illustrated.

At 606, the source device provides priority table information. For example, in one embodiment, an STK function in the security module 114 is initialized and executed to provide the priority table information. In this way, the provider of the mobile device 104 or the provider of the security module 114 may determine how the priority table 186 will be loaded. In other embodiments, the source device provides the priority table information wirelessly via the HCE interface 122. In one or both of these cases, the priority table information may be encrypted or otherwise obfuscated.

The priority table information may include application identifiers (AIDs), links to processor executable software functions associated with the AIDs (e.g., programs, applications, applets, STK application, commands, directions, and the like), and other information. In some embodiments, the information received includes at least one processor executable software function stored in a security module, in other embodiments, the information received represents at least one processor executable software function executable stored outside of the security module by a remote computing device, and in still other embodiments, processor executable software functions stored in both a security module and a remote computing device are represented.

Also at 606, an application identifier (AID) prioritization table such as priority table 186 is loaded and prepared for use. In some cases, preparing the table for use includes sorting the priority table 186 so that at least one of the processor executable software functions stored in the security module is prioritized over the corresponding processor executable software function executable outside of the security module. In other cases, one or more variable priority numbers are added to the priority table 186 and the variable priority numbers are associated with the particular processor executable software functions stored in the security module 114 or particular processor executable software functions stored elsewhere and executable by a remote computing device via HCE interface 122. In this way, by selecting appropriate variable priority numbers, internal security module 114 functions may be prioritized over or under external functions directed through the HCE interface.

Continuing at 606, other acts may also be performed. For example, the priority table 186 may be re-sorted as directed by a network service provider 134, an STK application stored and executed on the security module 114, a program or function executed by a host processor 118a, or by some other device and mechanism.

At 608, a transaction is received via the secure wireless interface 112a. The transaction may be an NFC transaction, and the transaction may include a request to access secure data. The secure data may be stored in the security module or the secure data may be stored in a remote computing device. The transaction may be a financial transaction, a transaction with a merchant and associated with goods or services, a transaction with a health care provider, or some other transaction.

At 610, the information associated with the transaction is retrieved. One datum retrieved may include an application identifier (AID) or other similar information. The priority table is then interrogated to retrieve information associated with the AID. In some cases, the retrieved information includes an address, a pointer, or some other information representing a function stored in the security module 114. In other cases, the retrieved information directs a function or application associated with a remote computing device, and in these cases, the represented action is accessed via the HCE interface 122.

At 612, the function associated with the transaction is performed either internally or externally. If the function is performed internally, the function is performed by an STK application or other executable function stored in the security module 114. If the function is performed externally, execution of the function is directed via the HCE interface 122.

Program flow 600 is ongoing and no termination of the program is represented in FIG. 6.

Secure data, as used herein, is electronically stored information that a typical user would desire to keep from being generally known or otherwise freely available. A non-limiting list of examples includes bank account numbers or account numbers associated with other financial institutions; credit card numbers and associated data; debit card numbers and associated data; birthdays; passwords; personal identification numbers (PINs); health information; private phone numbers or other private contact information; social security information; passport information; mobile account information; biometric data such as fingerprints, iris scans, and the like; tax identifiers or other information associated with taxes; registration information for vehicles, firearms, and other personal and real property; photographs or other media; videos or other multimedia; and any other type of information that a person or entity would desire to keep private (e.g., secret) and that can be stored electronically. Other information that a typical user would desire to secure and control is also contemplated.

Security modules, such as security module 114 (FIG. 4), which may also be referred herein as a subscriber identity module (SIM), is sometimes embodied as a small, square or rectangle having one truncated corner. The SIM has at least one integrated memory device, and some limited computing functionality. The particular shape, electronic pin configuration, and operational characteristics of the SIM card are in some cases governed by one or more Global System for Mobile Communications (GSM) mobile communications standards.

In other cases, security modules are embodied as a Universal Integrated Circuit Card (UICC). The UICC is considered a newer generation SIM. The UICC is generally compatible with mobile communication systems that comply with 3G and 4G telecommunications standards as well as some non-GSM telecommunications standards. The UICC includes a computing processor, data storage memory, and executable software, which is often embodied in one or more applications that run on the computing processor. For example, a USIM application provides activated profile functionality to identify the subscriber and associated contracted services to a mobile network services provider. A UICC is conventionally compatible with Universal Mobile Telecommunications Systems (UMTS), High Speed Packet Access (HSPA) systems, Long Term Evolution (LTE) systems, carrier detect multiple access (CDMA) systems, and other systems. The UICC may also provide applications for Intelligent SIM (ISIM) to secure mobile access to multimedia services and other non-telecom applications such as mobile payment services, financial services, banking services, private healthcare services, and the like.

In still other cases, an embedded mobile UICC (eUICC) device or some other logic in a mobile device performs the functions described herein with respect to the security module 114 of FIG. 4.

Non-limiting embodiments of computing devices are referenced herein but not described in detail for the sake of brevity and simplicity. The computing devices are understood to include operative hardware found in a conventional computing apparatuses such as one or more central processing units (CPU's), volatile and non-volatile memory, serial and parallel input/output (I/O) circuitry compliant with various standards and protocols, wired and/or wireless networking circuitry (e.g., a communications transceiver), and the like.

Along these lines, the terms processor, processing unit, and the like are used in the present disclosure to refers to one or more processing units individually, shared, or in a group, having one or more processing cores (e.g., execution units), including central processing units (CPUs), digital signal processors (DSPs), microprocessors, micro controllers, state machines, and the like that execute instructions. For example, as used herein, a processing unit may include all or any portions of a host applications processor, a baseband processing unit, a security module processing unit, and other processing units in a single structure or a distributed structure.

In the present disclosure, various software applications, applets, and the like are discussed. The software discussed herein is formed of processor-executable instructions stored in a memory. The memory may be arranged in one configuration or another. The memory may be arranged to store data. In the alternative or in addition, the memory may be a non-transitory computer readable medium (CRM) wherein the CRM is configured to store instructions executable by a processor. The instructions may be stored individually or as groups of instructions in files. The files may include functions, services, libraries, and the like. The files may include one or more computer programs or may be part of a larger computer program. Alternatively or in addition, each file may include data or other computational support material useful to carry out the computing functions of the systems, methods, and apparatus described in the present disclosure.

In the present disclosure the term “mobile device” is used to indicate a computing device capable of communicating through a wireless communications network such as a cellular mobile device network, a satellite mobile device network, or some other mobile device network. It is understood that the device capable of such communication may itself be mobile or otherwise portable. Conversely, the device capable of such communication may be temporarily or permanently stationary. As used herein, a mobile device may be embodied as cellular phone, a smartphone, a tablet, a laptop computer, a wearable computer, a motor vehicle computer, or some other like device. The term mobile device as used herein is not intended to be limiting; instead, the term is used to help a reader understand various embodiments of the disclosure.

The term “logic,” as used herein, may refer to circuitry, software, or a combination of circuitry and software.

As used herein, the term “module” refers to an electronic circuit, a processor (e.g., shared, dedicated, group, single core, multicore, or the like) and memory operative to execute one or more software or firmware programs, an application specific integrated circuit (ASIC), a combinational logic circuit, or some other individual or cooperative coupling of suitable components (either hardware or software) that provides the functionally described with respect to the module.

Non-limiting embodiments of computing devices are referenced herein but not described in detail for the sake of brevity and simplicity. The computing devices are understood to contain operative hardware found in a conventional computing apparatuses such as one or more central processing units (CPU's), volatile and non-volatile memory, serial and parallel input/output (I/O) circuitry compliant with various standards and protocols, wired and/or wireless networking circuitry (e.g., a communications transceiver), and the like.

Any flowcharts presented herein, even unconventional flowcharts wherein blocks are illustrated to communicate data, illustrate processes that may be used by embodiments of the devices described herein to load a prioritized AID routing table. In this regard, each described process may represent a module, segment, or portion of software code, which comprises one or more executable instructions for implementing the specified logical function(s). It should also be noted that in some implementations, the functions noted in the process may occur in a different order, may include additional functions, may occur concurrently, and/or may be omitted.

In the foregoing description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with electronic and computing systems including client and server computing systems, as well as networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, e.g., “including, but not limited to.”

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

The various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method to prioritize secure transactions, comprising:
initializing a communication path to a secure wireless interface circuit of a mobile device;
providing priority table information, the priority table information including application identifiers and links to processor executable software functions associated with the application identifiers, at least one of the processor executable software functions stored in a security module wherein the at least one of the processor executable software functions stored in the security module is prioritized over a corresponding processor executable software function executable outside of the security module; and
loading a priority table in the secure wireless interface circuit with the priority table information passed over the communication path.

2. The method of claim 1 wherein the at least one of the processor executable software functions stored in the security module is prioritized over the corresponding processor executable software function executable outside of the security module in an act that includes sorting the priority table information.

3. The method of claim 1 wherein the at least one of the processor executable software functions stored in the security module is prioritized over the corresponding processor executable software function executable outside of the security module in an act that includes adding a variable priority number to the priority table and associating the variable priority number with the at least one of the processor executable software functions stored in the security module.

4. The method of claim 1 wherein the security module is a subscriber identity module (SIM) card, the mobile device is a smartphone, and the secure wireless interface circuit conforms to a near field communication (NFC) architecture.

5. The method of claim 1 wherein the communication path is formed between the security module and the secure wireless interface circuit of the mobile device.

6. The method of claim 1 wherein the communication path is formed between a remote computing device and the secure wireless interface circuit of the mobile device via a host-card-emulation (HCE) interface.

7. The method of claim 1, comprising:
initializing a subscriber identity module toolkit (STK) function in the security module of the mobile device; and
executing the STK function to provide the priority table information.

8. The method of claim 1, comprising:
receiving a transaction via the secure wireless interface circuit;
parsing the transaction to retrieve an application identifier (AID); and
retrieving from the priority table, based on the AID, information representing a function to execute, wherein the function to execute is either stored on the security module or stored on a remote computing device.

9. The method of claim 8, comprising:
directing execution of the function to execute via a host-card-emulation (HCE) interface.

10. The method of claim 8, comprising:
directing execution of the function to execute via a host-card-emulation (HCE) interface; and
activating an executable function associated with the priority table via a user interface of the mobile device.

11. A security module, comprising:
a secure wireless interface circuit; and
a memory associated with the secure wireless interface circuit, the memory arranged to store a priority table, the priority table configured to store:
a plurality of application identifiers;
links to processor executable software functions associated with the application identifiers, at least a first one of the processor executable software functions stored in the security module and at least a second one of the processor executable software functions executable outside of the security module; and
information to prioritize either the first one of the processor executable software functions or the second one of the processor executable software functions.

12. The security module of claim 11 wherein the security module is a subscriber identity module (SIM) card.

13. The security module of claim 11 wherein the security module is associated with a smartphone.

14. The security module of claim 11 wherein the secure wireless interface circuit conforms to a near field communication (NFC) architecture.

15. The security module of claim 11 wherein the memory is arranged to store a subscriber identity module toolkit (STK) application that directs operations of the security module associated with the priority table.

16. A non-transitory computer-readable storage medium whose stored contents configure a computing system to perform a method, the method comprising:
initializing a subscriber identity module toolkit (STK) function in a security module of a mobile device;
executing the STK function, the executing causing acts including:
initializing a communication path between the security module and a secure wireless interface circuit;
loading a priority table with application identifiers, links to processor executable software functions associated with the application identifiers, and prioritization information indicating a priority of at least one first application identifier over at least one second application identifier.

17. The non-transitory computer-readable storage medium according to claim 16 whose stored contents configure the computing system to perform the method, wherein a first one of the processor executable software functions is stored in the security module and wherein a second one of the processor executable software functions is executable outside of the security module.

18. The non-transitory computer-readable storage medium according to claim 17 whose stored contents configure the computing system to perform the method, wherein the first one of the processor executable software functions stored in the security module is prioritized over the second one of the processor executable software functions executable outside of the security module.

19. The non-transitory computer-readable storage medium according to claim 16 whose stored contents configure the computing system to perform the method, the method further comprising:
receiving a transaction via the secure wireless interface circuit;
parsing the transaction to retrieve an application identifier (AID); and
retrieving from the priority table, based on the AID, information representing a function to execute, wherein the function to execute is either stored on the security module or stored on a remote computing device.

20. The non-transitory computer-readable storage medium according to claim 19 whose stored contents configure the computing system to perform the method, the method further comprising:
attempting to execute one or another of the function to execute that is stored on the security module and the function to execute that is stored on the remote computing device; and
if the one function to execute is not executed, attempting to execute the other function to execute.
